(19) United States
(12) Patent Application Publication
(10) Pub. No.: US 2014/0250410 A1
(43) Pub. Date: Sep. 4, 2014

(54) SCHEDULING MENU SYSTEM AND METHOD HAVING FLIP STYLE GRAPHICAL DISPLAY

(71) Applicant: Triology LLC, Milton (AU)

(72) Inventor: Jonathan Eaves, Milton (AU)

(73) Assignee: Triology LLC, Milton (AU)

(21) Appl. No.: 14/196,121

(22) Filed: Mar. 4, 2014

Related U.S. Application Data
(60) Provisional application No. 61/772,326, filed on Mar. 4, 2013.

(51) Int. Cl. G06F 3/0482; G06F 3/0488

(52) U.S. Cl. CPC G06F 3/0482; G06F 3/0488
USPC 715/810

(57) ABSTRACT

Scheduling menu systems of the present technology can be implemented by a digital device comprising a touch screen display device having a field of view, at least one processor operably connected to the touch screen display device, and a non-transitory computer readable medium on which program instructions for the scheduling menu can be stored. The scheduling menus can include an interactive graphic display including a date graphic icon operatively associated with a first interactive area of the touch screen display device, and an activity graphic icon operatively associated with a second interactive area of the touch screen display device, each of which is a flip style icon having a plurality of selectable leaf pages.

### RELATED APPLICATIONS

This application claims priority to U.S. Provisional Application Ser. No. 61/772,326, filed on Mar. 4, 2013, currently pending, the disclosure of which is hereby incorporated by reference in its entirety.

### FIELD OF THE INVENTION

The present technology relates to menu systems for digital devices, such as computers, tablets, and smart phones.

### SUMMARY OF THE INVENTION

The present technology includes digital devices having a scheduling menu with a flip style graphical display, instructions stored on a computer readable medium that provide such a menu when the instructions are executed by a digital device, and a method for using same.

In one aspect, a system providing a scheduling menu on a digital device. The system comprises a touch screen display device having a field of view, at least one processor operably connected to the touch screen display device, and a non-transitory computer readable medium. The system also comprises program instructions stored on the non-transitory computer readable medium and executable by the at least one processor that, when executed, cause the at least one processor to: display on the touch screen display device an interactive graphic display including a date graphic icon operatively associated with a first interactive area of the touch screen display device, wherein the date graphic icon is an interactive flip style date icon having a plurality of selectable leaf pages, each leaf page identifying a date; receive a date change command, input by a user touch in the first interactive area; and alter the appearance of the date graphic icon by scrolling through one or more leaf pages of the date icon in response to the date change command.

In another aspect, a method is provided that can be implemented by a digital device comprising a touch screen display device having a field of view, at least one processor operably connected to the touch screen display device, and a non-transitory computer readable medium. The digital device performs steps of: storing program instructions on the non-transitory computer readable medium, the program instructions being executable by at least one processor; and causing the at least one processor to execute the program instructions. Execution of the program instructions causes the at least one processor to: display on the touch screen display device an interactive graphic display including a date graphic icon operatively associated with a first interactive area of the touch screen display device, wherein the date graphic icon is an interactive flip style date icon having a plurality of selectable leaf pages, each leaf page identifying a date; receive a date change command, input by a user touch in the first interactive area; and alter the appearance of the date graphic icon by scrolling through one or more leaf pages of the date icon in response to the date change command.

In a third aspect, a non-transitory computer-readable medium having program instructions stored thereon is provided. The program instructions comprise: instructions for causing at least one processor to display on a touch screen display device an interactive graphic display including a date graphic icon operatively associated with a first interactive area of the touch screen display device, wherein the date graphic icon is an interactive flip style date icon having a plurality of selectable leaf pages, each leaf page identifying a date; instructions for causing at least one processor to receive a date change command, input by a user touch in the first interactive area; and instructions for causing at least one processor to alter the appearance of the date graphic icon by scrolling through one or more leaf pages of the date icon in response to the date change command.

### BRIEF DESCRIPTION OF THE DRAWINGS

Specific examples have been chosen for purposes of illustration and description, and are shown in the accompanying drawings, forming a part of the specification.

FIG. 1 illustrates one example of a digital device on which a scheduling menu of the present technology can be displayed.

FIG. 2 illustrates a schematic for a system providing a scheduling menu on a digital device of FIG. 1.

FIG. 3 illustrates one example of an interactive graphic display of a scheduling menu of the present technology, having a date graphic icon and an activity graphic icon.

FIG. 4 illustrates the interactive graphic display of FIG. 3, with one leaf page of the menu system in an intermediate flipping position.

FIG. 5 illustrates one example of interactive areas of the touch screen display device of the digital device of FIG. 1.

FIG. 6 illustrates one example of a time graphic icon of a scheduling menu of the present technology.

### DETAILED DESCRIPTION

Scheduling menu systems of the present technology include scheduling menus provided on digital devices, such as computers, tablets, and smart phones. Scheduling menus of the present technology can be stored on, executed by and displayed by the digital devices. The scheduling menus can be created in the form of computer readable and executable instructions, or software, that can be executed by one or more processors of a digital device. The scheduling menus can be stored on computer readable storage media, such as memory in a hard drive, a flash drive, or a disk.

In some examples, a software application containing the instructions for providing a scheduling menu of the present technology can be downloaded onto and stored in a non-transient computer readable storage medium, such as a memory, of a digital device owned by a user, and can then be executed by at least one processor of the digital device to provide the scheduling menu to the user.

In some examples, scheduling menus of the present technology utilize interactive graphic displays on touch screen display devices. Interactive graphic displays can include one or more graphic icons displayed in a field of view of the touch screen display device. An interactive area of the touch screen display device, formed by at least a portion of the surface area of the touch screen display device, is operatively associated with each graphic icon displayed. The interactive area allows a user to use a finger to select and interact with the associated graphic icon.

The scheduling menu provides a touch based form of a menu, utilizing three core actions: previous, next, and select. Previous and next are used to move through the menu options, and select initiates an action. There are several actions that can be initiated. One is to execute the action that has been selected by executing software code associated with that option. Another is to display a new set of options on the same menu. By presenting a new set of menu options after selecting an option, this scheduling menu can be used to provide hierarchal options, similar to cascading menus used in window/mouse based GUIs.

The scheduling menu could appear permanently in an application, or only appear on certain screens when required. For example if the scheduling menu is used as a form of navigation in the application, it would likely be displayed permanently in the same place on screen. This allows users to jump to different screens in the application quickly. Alternatively if the menu appears freshly on a screen, it is to provide the user with options relevant to that screen. When displaying the menu, the software needs to first determine a set of options to display to the user. These options could be a fixed list stored on the device, or dynamically generated based on data from a database, or calculated if a range of dates or times need to be presented to the user. In fact any form of data and logic can be combined to determine which options should be presented to the user, the same as any other scheduling menu found on a computing device.

Each option generated would need to be rendered on the scheduling menu. This rendering could be based on associated images in a database, rendered text and graphics (e.g. text showing a date, with an icon), or a combination of the two. For example if presenting a list of users with avatars, the user's name could be rendered on top of the user's avatar image to provide a graphical representations of the users to flip through.

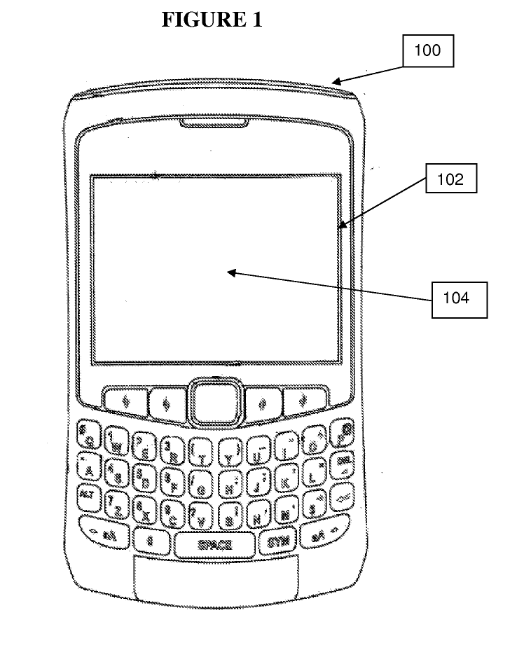

FIG. 1 illustrates one example of a digital device 100 that includes a touch screen display device 102 having a field of view 104, that can be used to implement scheduling menus of the present technology.

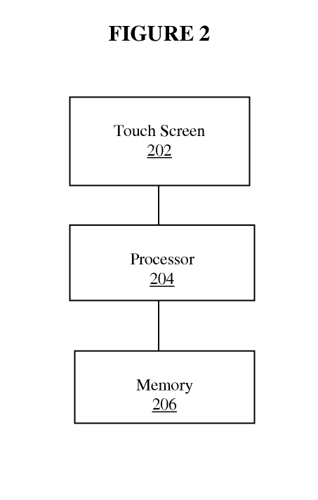

FIG. 2 illustrates a schematic for a system 200 providing a scheduling menu on a digital device, such as the digital device of FIG. 1. The illustrated system 200 includes a touch screen display device 202, at least one processor 204 operably connected to the touch screen display device 202, and a non-transitory computer readable medium, such as memory 206. The non-transitory computer readable medium can have program instructions stored thereon that are executable by the at least one processor 204. When executed by the at least one processor 204, the program instructions can cause the at least one processor to display on the touch screen display device 202 an interactive graphic display of the scheduling menu.

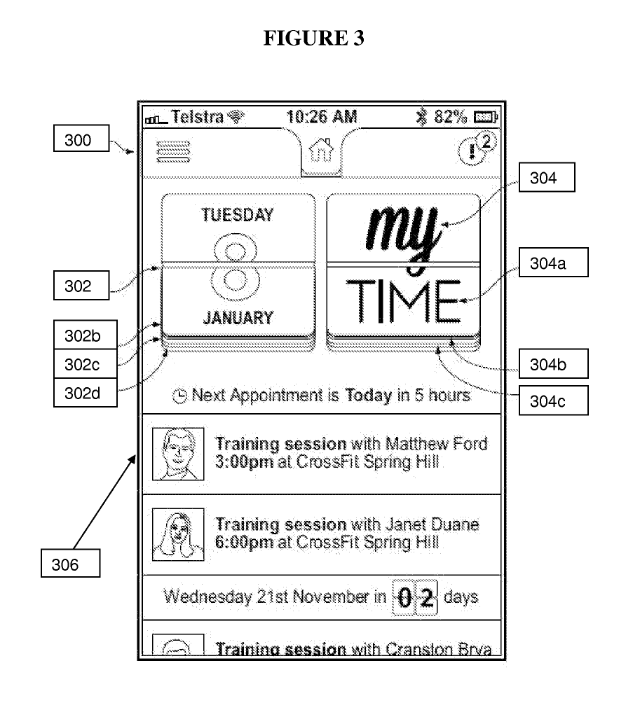

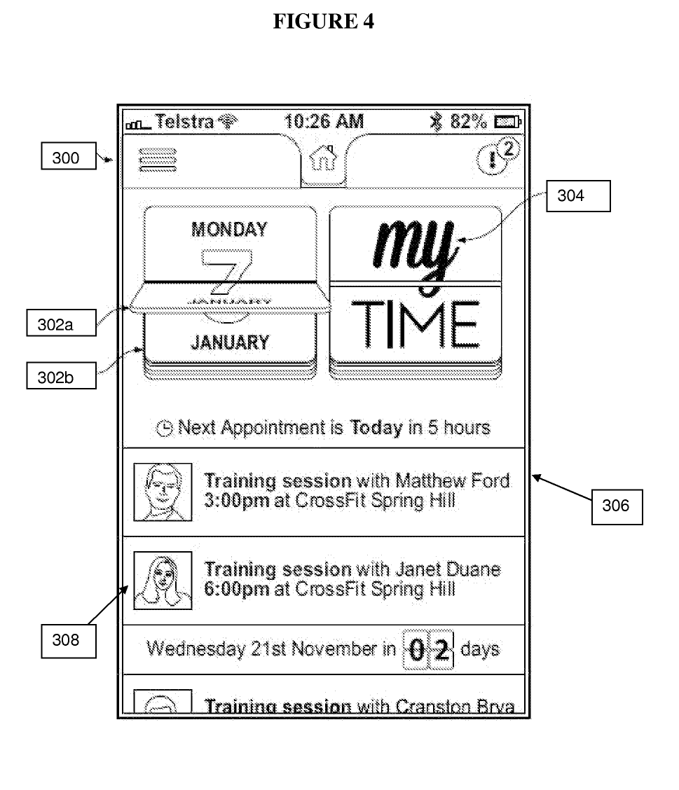

FIGS. 3 and 4 illustrate one example of an interactive graphic display 300 of a scheduling menu of the present technology. The interactive graphic display 300 can include one or more selectable options, which can be in the form of graphic icons. As shown, the interactive graphic display includes a date graphic icon 302, which is operatively associated with a first interactive area of the touch screen display device. The interactive graphic display as shown also includes an activity graphic icon 304, which is operatively associated with a second interactive area of the touch screen display device. Alternatively, the interactive graphic display 300 can include one or greater than two selectable options.

Each graphic icon for a selectable option can be displayed as an interactive flip style graphic that has a plurality leaf pages, where each leaf page displays one entry of a subset of available entries for the selectable option. For example, the date graphic icon 302 is an interactive flip style date icon having a plurality of selectable leaf pages 302a, 302b, 302c, and 102d, each leaf page identifying a date. Similarly, the activity graphic icon is an interactive flip style activity icon having a plurality of selectable leaf pages 304a, 304b, and 304c, each leaf page identifying a type of activity. It should be understood that although a limited number of leaf pages are illustrated, the potential number of leaf pages allowed in each selectable option is unlimited.

Each leaf page for the date graphic icon 302 can include information identifying a particular date, including the day of the week, the numerical identification of the date within the month, and the month.

Each leaf page for the activity 304 can include an identifier for a particular type of activity. Some examples of values for the subset of activities that may be included in the leaf pages include: fitness, tennis, golf, salon, chiro, physio, baby, check-up, ortho, osteo, massage, acupuncture, zen, medicine, treatment, hair, nails, style, doctor, soccer, court, squash, game, tuneup, service, pro, class, judo, fight, box, session, training, quote, run, pilates, yoga, dance, zumba, relax, care, sport, team, squad, swim, aerobics, step, and hoops or basketball. The list of available activities might be fixed, or dynamically generated based on what is available on the displayed date.

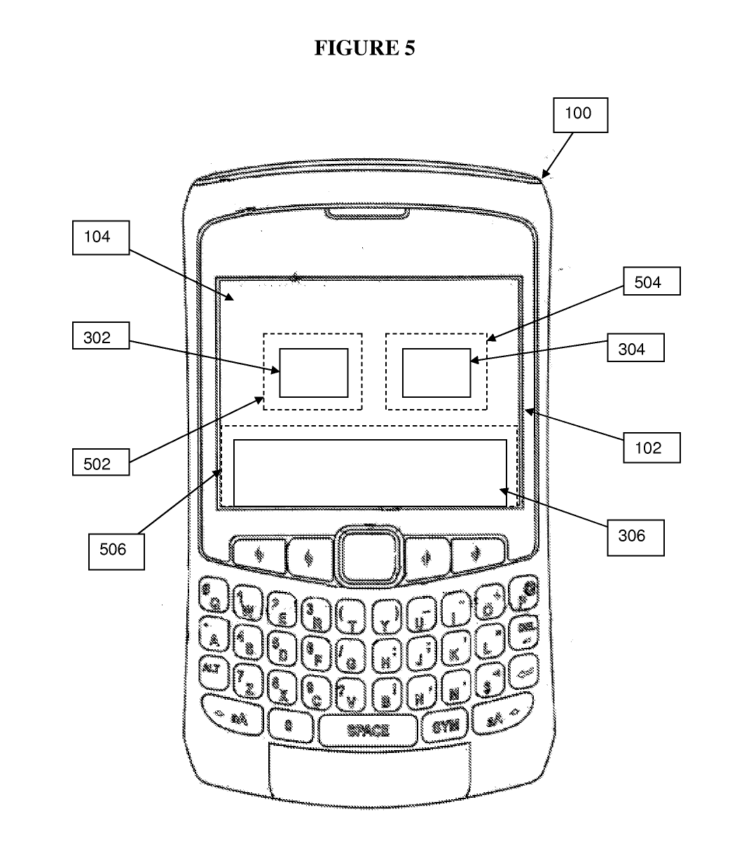

As shown in FIG. 5, when a user desires to switch from one date to another, the user can use a finger to input a date change command in the first interactive area 502 of the touch screen, which is operatively associated with the date graphic icon 302. The first interactive area 502 can be the same size or larger than the date graphic icon 302. In the illustrated example, the first interactive area 502 is larger than the date graphic icon 302, and is defined by the dimensions of the date graphic icon 302 plus a margin of operation around the date graphic icon 302. The user can input a date change command by touch, such as either a tap or a swipe up or down, in the first interactive area 502 to scroll through the leaf pages of the date graphic icon 302. In some embodiments, tapping on a leaf page or leaving a leaf page in stasis will select the date currently displayed for the selectable option.

In response to the date change command, the at least one processor of the system can alter the appearance of the date graphic icon by scrolling through one or more leaf pages of the date icon. As shown in FIGS. 3 and 4, the program instructions being executed by the system can cause the at least one processor to visually display the scrolling on the touch screen device as a flip book, where each leaf page is displayed at one or more intermediate flipping positions. FIG. 4 shows the leaf page 302 in an intermediate flipping position as a user scrolls from leaf page 302a, representing Monday, the 7th of January, to leaf page 302b, representing Tuesday, the 8th of January.

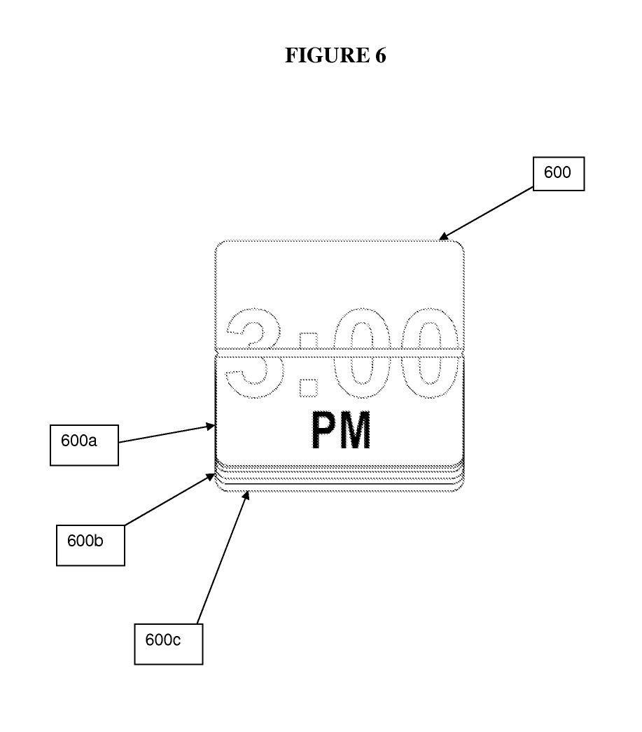

In some examples of scheduling menus of the present technology, when the at least one processor receives a date selection command, input by a user touch on a displayed date of the date graphic icon 302 in the first interactive area 502, the at least one processor can replace the date graphic icon with a time graphic icon 600, as shown in FIG. 6. Like the date graphic icon 302, the time graphic icon 600 can be operatively associated with the first interactive area 502 of the touch screen display device. The time graphic icon 600 can be an interactive flip style date icon having a plurality of selectable leaf pages, such as leaf pages 600a, 600b, and 600c. Each leaf page can identify a time of day. The time of day can, for example, be represented in twelve hour format, with a.m. and p.m. designations, or in twenty-four hour format. In one example, the range of times provided by the leaf pages of the time graphic icon 600 can be fixed, such as providing a business hour range from 9 a.m. to 5 p.m. in 30 minute intervals. In another example, the range of times provided by the leaf pages of the time graphic icon 600 can be generated by logic within the program instructions that determines and presents available appointments for the selected activity.

As also shown in FIG. 5, when a user desires to switch from one activity to another, the user can use a finger to input an activity change command in the second interactive area 504 of the touch screen display device, which is operatively associated with the activity graphic icon 304. The second interactive area 504 can be the same size or larger than the activity graphic icon 304. In the illustrated example, the second interactive area 504 is larger than the activity graphic icon 304, and is defined by the dimensions of the activity graphic icon 304 plus a margin of operation around the date graphic icon 302. The user can input an activity change command by touch, such as either a tap or a swipe up or down, in the second interactive area 504 to scroll through the leaf pages of the activity graphic icon 304. The scheduling menu system can receive an activity selection command, input by a user touch on a displayed activity of the activity graphic icon 304 in the second interactive area 504. In some embodiments, tapping on a leaf page or leaving a leaf page in stasis will select the activity currently displayed for the selectable option. In response to the activity change command, the at least one processor of the system can alter the appearance of the activity graphic icon 304 by scrolling through one or more leaf pages of the activity graphic icon 304.

In some examples, when the at least one processor receives an activity selection command, the at least one processor can replace the activity graphic icon 304 with another graphic icon operatively associated with the second interactive area 504 of the touch screen display device. Examples of other graphic icons can include relevant informational subsets, that can include entries, for example, that permit the user to select additional details for the activity, such as the location, other participants and other information (for example, “training session”, etc.).

To achieve the scrolling effect for each of the graphic icons, 3D graphics rendering can be employed by the software. As the user swipes up and down, the angle of the intermediate leaf page changes proportional to the distance the user has swiped. The flip speed can be adjusted to allow a single flip for a full swipe, or increased to allow multiple flips per full swipe distance. The swipe distance is generally the bounds of the visible leaf page. This allows the user to quickly scroll through multiple options and still be able to stop on an option by releasing their finger from the touch screen.

A user can stop mid swipe to stop on the currently most displayed leaf page. The user can change direction of the swipe to flip back through recently displayed options. The user may not be required to release their finger from the screen to achieve this, rather it can be one fluid motion.

In practice, when the interactive graphic display includes a plurality of graphic icons displayed at once in the field of view 104 of the touch screen display device 102, the program instructions can include logic that causes the graphic icons may interact with each other, meaning that selection of a leaf page on one graphic icon may dictate the content provided on the leaf pages of another graphic icon. For example, referring to FIG. 2, if a user wishing to book an appointment inputs a date selection command using the date graphic icon 302, the activities identified on the activity graphic icon 304 may be limited to activities available on that date. Conversely, a user wishing to book an appointment can inputs an activity selection command using the activity graphic icon 304, and the dates identified on the date graphic icon 302 may be limited to dates with available appointments for that activity.

As shown in FIGS. 3 and 4, the interactive graphic display can also include a schedule summary 306, that can provide a listing of scheduled activities. The schedule summary 306 can be partially displayed in the field of view 104 of the touch screen display device, and can be associated with a third interactive area 506 of the touch screen display device. A user can select a scheduled activity 308 from the schedule summary 306, or can scroll through the schedule summary 306 by inputting touch commands in the third interactive area 506.

Preferably, the operating system of the digital device on which the scheduling menu is executed can dynamically add any entry to a leaf page within the set of entries for any selectable option. Thus, the scheduling menu can be modified and customized

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A system providing a scheduling menu on a digital device, the system comprising:
a touch screen display device having a field of view;
at least one processor operably connected to the touch screen display device;
a non-transitory computer readable medium; and
program instructions stored on the non-transitory computer readable medium and executable by the at least one processor that, when executed, cause the at least one processor to:
display on the touch screen display device an interactive graphic display including a date graphic icon operatively associated with a first interactive area of the touch screen display device, wherein the date graphic icon is an interactive flip style date icon having a plurality of selectable leaf pages, each leaf page identifying a date;
receive a date change command, input by a user touch in the first interactive area; and
alter the appearance of the date graphic icon by scrolling through one or more leaf pages of the date icon in response to the date change command.

2. The system of claim 1, wherein the first interactive area is defined by the dimensions of the date graphic icon plus a margin of operation.

3. The system of claim 1, wherein the program instructions cause the scrolling to be visually displayed on the touch screen device as a flip book, where each leaf page is displayed at one or more intermediate flipping positions.

4. The system of claim 1, wherein the program instructions stored on the non-transitory computer readable medium and executable by the at least one processor that, when executed, further cause the at least one processor to:
receive a date selection command, input by a user touch on a displayed date of the date graphic icon in the first interactive area; and
replace the date graphic icon with a time graphic icon, the time graphic icon being operatively associated with the first interactive area of the touch screen display device, wherein the time graphic icon is an interactive flip style date icon having a plurality of selectable leaf pages, each leaf page identifying a time of day.

5. The system of claim 4, wherein the program instructions stored on the non-transitory computer readable medium and executable by the at least one processor that, when executed, further cause the at least one processor to:
receive a time change command, input by a user touch in the first interactive area; and
alter the appearance of the time graphic icon by scrolling through one or more leaf pages of the date icon in response to the time change command.

6. The system of claim 5, wherein the program instructions stored on the non-transitory computer readable medium and executable by the at least one processor that, when executed, further cause the at least one processor to:
receive a time selection command, input by a user touch on a displayed time of the time graphic icon in the first interactive area.

7. The system of claim 1, wherein the interactive graphic display further includes an activity graphic icon operatively associated with a second interactive area of the touch screen display device, wherein the activity graphic icon is an interactive flip style activity icon having a plurality of selectable leaf pages, each leaf page identifying a type of activity.

8. The system of claim 7, wherein the program instructions stored on the non-transitory computer readable medium and executable by the at least one processor that, when executed, further cause the at least one processor to:
receive an activity change command, input by a user touch in the second interactive area; and
alter the appearance of the activity graphic icon by scrolling through one or more leaf pages of the activity icon in response to the activity change command.

9. The system of claim 8, wherein the program instructions stored on the non-transitory computer readable medium and executable by the at least one processor that, when executed, further cause the at least one processor to:
receive an activity selection command, input by a user touch on a displayed activity of the activity graphic icon in the second interactive area.

10. A method implemented by a digital device comprising a touch screen display device having a field of view, at least one processor operably connected to the touch screen display device, and a non-transitory computer readable medium, wherein the digital device performs steps of:
storing program instructions on the non-transitory computer readable medium, the program instructions being executable by at least one processor; and
causing the at least one processor to execute the program instructions, wherein execution of the program instructions causes the at least one processor to:
display on the touch screen display device an interactive graphic display including a date graphic icon operatively associated with a first interactive area of the touch screen display device, wherein the date graphic icon is an interactive flip style date icon having a plurality of selectable leaf pages, each leaf page identifying a date;
receive a date change command, input by a user touch in the first interactive area; and
alter the appearance of the date graphic icon by scrolling through one or more leaf pages of the date icon in response to the date change command.

11. The method of claim 10, wherein the scrolling is visually displayed on the touch screen device as a flip book, where each leaf page is displayed at one or more intermediate flipping positions.

12. The method of claim 10, wherein execution of the program instructions causes the at least one processor to:
receive a date selection command, input by a user touch on a displayed date of the date graphic icon in the first interactive area; and
replace the date graphic icon with a time graphic icon, the time graphic icon being operatively associated with the first interactive area of the touch screen display device, wherein the time graphic icon is an interactive flip style date icon having a plurality of selectable leaf pages, each leaf page identifying a time of day.

13. The method of claim 12, wherein execution of the program instructions causes the at least one processor to:
receive a time change command, input by a user touch in the first interactive area; and
alter the appearance of the time graphic icon by scrolling through one or more leaf pages of the date icon in response to the time change command.

14. The method of claim 13, wherein execution of the program instructions causes the at least one processor to:
receive a time selection command, input by a user touch on a displayed time of the time graphic icon in the first interactive area.

15. The method of claim 10, wherein the interactive graphic display further includes an activity graphic icon operatively associated with a second interactive area of the touch screen display device, wherein the activity graphic icon is an interactive flip style activity icon having a plurality of selectable leaf pages, each leaf page identifying a type of activity.

16. The method of claim 15, wherein execution of the program instructions causes the at least one processor to:
receive an activity change command, input by a user touch in the second interactive area; and
alter the appearance of the activity graphic icon by scrolling through one or more leaf pages of the activity icon in response to the activity change command.

17. The method of claim 16, wherein execution of the program instructions causes the at least one processor to:
receive an activity selection command, input by a user touch on a displayed activity of the activity graphic icon in the second interactive area.

18. A non-transitory computer-readable medium having program instructions stored thereon, the program instructions comprising:
instructions for causing at least one processor to display on a touch screen display device an interactive graphic display including a date graphic icon operatively associated with a first interactive area of the touch screen display device, wherein the date graphic icon is an interactive flip style date icon having a plurality of selectable leaf pages, each leaf page identifying a date;
instructions for causing at least one processor to receive a date change command, input by a user touch in the first interactive area; and
instructions for causing at least one processor to alter the appearance of the date graphic icon by scrolling through one or more leaf pages of the date icon in response to the date change command.

19. The non-transitory computer-readable medium of claim 18, wherein the interactive graphic display further includes an activity graphic icon operatively associated with a second interactive area of the touch screen display device, wherein the activity graphic icon is an interactive flip style activity icon having a plurality of selectable leaf pages, each leaf page identifying a type of activity.

20. The non-transitory computer-readable medium of claim 18, wherein the program instructions further comprise:
instructions for causing at least one processor to receive a date selection command, input by a user touch on a displayed date of the date graphic icon in the first interactive area.
